(19) United States
(12) Patent Application Publication
(10) Pub. No.: US 2008/0215966 A1
(43) Pub. Date: Sep. 4, 2008

(54) ADAPTIVE SERVER-BASED LAYOUT OF WEB DOCUMENTS

(75) Inventor: Carlos Garcia Jurado Suarez, Redmond, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/754,990

(22) Filed: May 29, 2007

Related U.S. Application Data
(60) Provisional application No. 60/892,535, filed on Mar. 1, 2007.

(51) Int. Cl. G06F 17/00

(52) U.S. Cl. 715/252; 715/243; 715/248; 715/259

(57) ABSTRACT

A server anticipates and pre-computes different layouts of online documents and stores them in cache. The layouts are specifically optimized for viewing across a range of display sector sizes. For each document, the layouts are stored in a directory that includes a common dictionary file and a separate layout file for each display sector size. Furthermore, a client requests a document from the server which in response sends the client a handler module which runs in the background on the client, detects the current size of the display sector being used by the client to display pages of the requested document and sends a request to the server for the document's dictionary file and specific layout file corresponding to the current display sector size. In response, the server retrieves these files from cache and sends them to the client. The handler then creates the document from these files.

### CROSS REFERENCE TO RELATED APPLICATION

This application claims the benefit of and priority to provisional U.S. patent application Ser. No. 60/892,535, filed Mar. 1, 2007.

### BACKGROUND

Documents which can contain a wide variety of different types of information are commonly sent over a computer network, such as the Internet or an intranet, from a server computer to a client computer. The documents are then commonly viewed by a user in an “online” fashion on a display device attached to the client. More particularly, the online documents are commonly displayed to the user in a sector of the display device via a web browser application program.

Unfortunately, conventional browsers are only capable of making very simple adaptations to the layout of documents they present to a user in order to accommodate different sizes of the sector on the display device that the browser is using to display the document, hereafter referred to as browser sector sizes. Examples of these simple document layout adaptations include text wrapping, cropping and providing the user with a graphical user interface (GUI) consisting of horizontal and vertical scroll bars which permit the user to scroll the browser sector across the document in order to view portions of the document which don't fit in the current size of the sector. This is not conducive to easy viewing or efficient comprehension of the document. Furthermore, if the user changes the size of the browser's sector on their display device, or changes the zoom factor by which the document is being viewed, the result is typically just a bigger or smaller version of the document, or worse yet, a document which is cropped or fills only a small portion of the browser sector. The layout of the document is not changed in any way to adapt to changes in the size of the browser sector in which the document is being viewed or the zoom factor by which the document is being viewed. As a result, a user's experience with viewing and comprehending documents on a client computer is adversely affected.

### SUMMARY

It is noted that this Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

The present technique for adaptive server-based layout of web documents generally involves a client/server computer network in which a server anticipates and pre-computes a prescribed number of different page layouts of online documents and stores them in a cache. The different page layouts are specifically adapted to and optimized for online viewing across a prescribed range of different display sector sizes. For each document, the various cached page layouts are stored in a directory that includes a common dictionary file, which contains a dictionary of all the text present in the document, and a separate layout file for each particular display sector size. The present technique further generally involves a client requesting a document from the server and in response the server sending the client a view request handler module which automatically runs in the background on the client. This handler detects the current size of the display sector being used by the client to display pages of the requested document and sends a request to the server for the document's dictionary file and the specific layout file corresponding to the current display sector size. In response, the server retrieves these files from its cache and sends them to the client. The handler on the client then creates the entire document from these files. A page of the document is then displayed by the client in the client's display sector.

It is also noted that while the foregoing shortcomings and disadvantages of viewing online documents using conventional web browsers and a conventional client/server computing environment described in the Background section can be resolved by a particular implementation of a technique for adaptive server-based layout of web documents according to the present invention, the subject matter claimed hereafter is in no way limited to implementations that just solve any or all of the foregoing shortcomings and disadvantages. Rather, the present technique has a much wider application as will become evident from the descriptions to follow.

### DESCRIPTION OF THE DRAWINGS

The specific features, aspects, and advantages of the present technique for adaptive server-based layout of web documents will become better understood with regard to the following description, appended claims, and accompanying drawings where:

FIG. 1 shows a diagram of general purpose, network-based computing devices which constitute an exemplary system for implementing the present technique.

FIG. 2 shows a diagram of a general client/server program module architecture for an exemplary embodiment of the present technique.

FIGS. 3A-3F show a flow chart diagramming an exemplary embodiment of a client/server process for adaptive server-based layout of online documents.

FIG. 4 shows a diagram of an exemplary embodiment of a general server cache file organization.

### DETAILED DESCRIPTION

In the following description of embodiments of the present technique for adaptive server-based layout of web documents reference is made to the accompanying drawings which form a part hereof, and in which are shown, by way of illustration, specific embodiments in which the present technique may be practiced. It is understood that other embodiments may be utilized and structural changes may be made without departing from the scope of the present technique.

It is noted that the term “sector” is used herein to refer to a segmented region of a computer display device (such as a monitor among other things) in which a particular type of graphical user interface (GUI) and/or information is displayed (such as an online document among other things), or a particular type of function is performed. It is also noted that the online documents discussed herein can contain a wide variety of different types of information including, but not limited to, text, images, animations, audio, video and web hyperlinks. Finally, it is noted that the “layout” of an online document as discussed herein refers to various attributes of the physical formatting of the viewable document which include, but are not limited to, its pagination, the number of columns, and the particular placement of the aforementioned different types of information that can be included in the document.

### 1.0 Computing Environment

Before providing a description of embodiments of the present technique for adaptive server-based layout of web documents, a brief, general description of a suitable computing environment in which portions thereof may be implemented will be described. This environment provides the foundation for the operation of embodiments of the present technique which are described hereafter. The present technique is operational with numerous general purpose or special purpose computing system environments or configurations. Examples of well known computing systems, environments, and/or configurations that may be suitable include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of these systems or devices, and the like.

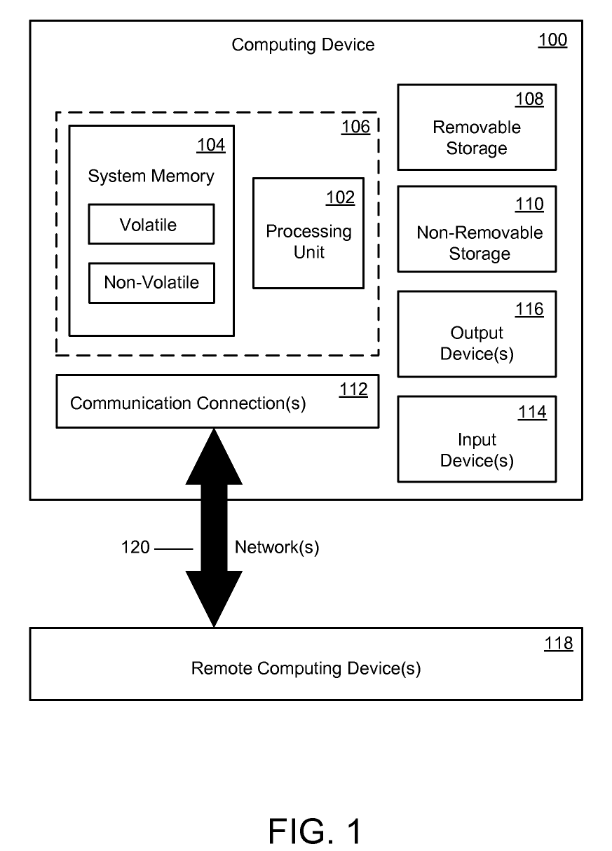

FIG. 1 shows an exemplary suitable computing environment. This is only one example of a suitable computing environment and is not intended to suggest any limitation as to the scope of use or functionality of the present technique. Neither should the computing environment be interpreted as having any dependency or requirement relating to any one or combination of components shown in the exemplary operating environment.

As shown in FIG. 1, an exemplary system for implementing the present technique includes one or more computing devices, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is shown in FIG. 1 by dashed line 106.

As shown in FIG. 1, device 100 can also have additional features and functionality. For example, device 100 can include additional storage such as removable storage 108 and/or non-removable storage 110. This additional storage includes, but is not limited to, magnetic disks, optical disks and tape. Computer storage media includes volatile and non-volatile media, as well as removable and non-removable media implemented in any method or technology. The computer storage media provides for storage of various information required to operate the device 100 such as computer readable instructions associated with an operating system, application programs and other program modules, data structures, etc. System memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by device 100. Any such computer storage media can be part of device 100.

As shown in FIG. 1, device 100 also includes a communications connection(s) 112 that allows the device to operate in a networked environment and communicate with remote computing device(s), such as remote computing device(s) 118. Remote computing device(s) 118 can be a PC, a server, a router, a peer device or other common network node, and typically includes many or all of the elements described herein relative to device 100. Communication between computing devices takes place over a network(s) 120, which provides a logical connection(s) between the devices. The logical connection(s) can include one or more different types of networks including, but not limited to a local area network(s) and a wide area network(s). Such networking environments are commonplace in conventional offices, enterprise-wide computer networks, intranets and the Internet. It is noted that the communications connection(s) 112 and related network(s) 120 discussed herein are exemplary and other means of establishing communication between the computing devices can be used.

As shown in FIG. 1, communications connection(s) 112 and related network(s) 120 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term “computer readable media” as used herein includes both storage media and communication media.

As shown in FIG. 1, device 100 also includes an input device(s) 114 and output device(s) 116. Examples of input device(s) 114 include, but are not limited to, a keyboard, mouse, pen, voice input device, touch input device, camera, etc. A user can enter commands and information into the device 100 through the input device(s) 114. Examples of output device(s) 116 include, but are not limited to, a display device(s) via which the user can view online documents and other types of information, speakers, printer, etc. All these input and output devices are well known in the art and need not be discussed at length here. However, it is noted that the display device(s) can have a wide range of different screen sizes and pixel resolutions.

The present technique can be described in the general context of computer-executable instructions, such as program modules, which are executed by computing device 100. Generally, program modules include routines, programs, objects, components, data structures, etc. that perform particular tasks or implement particular abstract data types. The present technique can also be practiced in distributed computing environments where tasks are performed by one or more remote computing devices 118 that are linked through a communications network 112/120. In a distributed computing environment, program modules may be located in both local and remote computer storage media including system memory 104 and storage devices 108/110.

An exemplary operating environment having now been described, the remainder of this Detailed Description section will be devoted to a description of the program modules and related processes that embody the present technique.

### 2.0 Adaptive Server-Based Layout of Web Documents

The present technique for adaptive server-based layout of web documents generally involves a client/server computer network in which a server anticipates and pre-computes a prescribed number of different page layouts of online documents and stores them in a cache. The different page layouts are specifically adapted to and optimized for online viewing across a prescribed range of different display sector sizes. For each document, the various cached page layouts are stored in a directory that includes a common dictionary file, which contains a dictionary of all the text present in the document, and a separate layout file for each particular display sector size.

A client on the client/server computer network requests a document from the server and in response the server sends the client a view request handler module which automatically runs in the background on the client. This handler detects the current size of the display sector being used by the client to display pages of the requested document and sends a request to the server for the document's dictionary file and the specific layout file corresponding to the current display sector size. In response, the server retrieves these files from its cache and sends them to the client. The handler on the client then creates the entire document from these files. A page of the document is then displayed by the client in the client's display sector.

Since the most common source of online documents today is the World Wide Web (herein referred to as the “web”) the online documents are herein also referred to as “web documents” and the network protocols used in tested embodiments of the present technique described hereafter are web-based protocols. It is noted that the present technique also supports sources of online documents other than the web and network protocols other than web-based protocols. The following sections provide descriptions of various embodiments of the present technique, starting with an architecture and followed by its operations.

### 2.1 Architecture

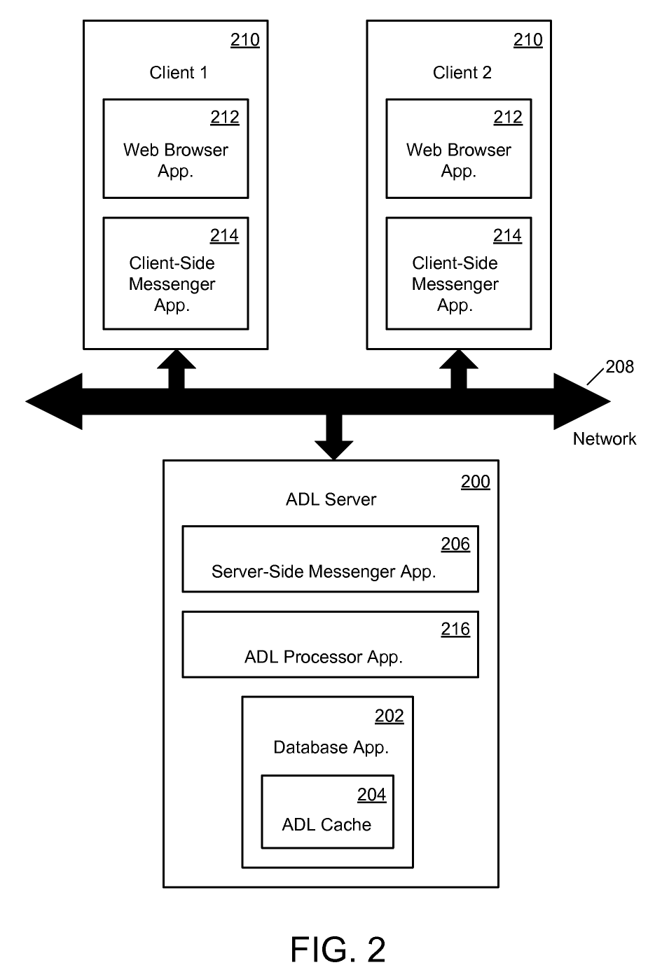

The general architecture of the present technique is based on a client/server scheme which is shown in simplified form in FIG. 2. At the heart of the architecture is an adaptive document layout (ADL) server computer 200 which includes a database application program 202 (hereafter simply referred to as a database), a server-side messenger application program 206 (hereafter simply referred to as a server-side messenger), and an ADL processor application program 216 (hereafter simply referred to as an ADL processor), among other things. The server 200 is connected to a computer network 208. The network 208 also provides connectivity to client computers 210. It is noted that while just two clients 210 are shown in FIG. 2 for the sake of simplicity, there could be many more. Among other things, a primary role of the database 202 is to store and maintain an ADL cache 204, and to access and update the contents of the cache in response to particular document page requests that are received from the clients 210. If a client 210 makes a document page layout request to the server 200 for a document that is not currently in the database 202, it is assumed herein that the document is readily accessible by the server. In general terms, a primary role of the ADL processor 216 is to compute a set of document page layouts for each document that is stored in the database 202. A primary role of the ADL cache 204 is to store the page layouts and their supporting information produced by the ADL processor 216.

As shown in FIG. 2, each client 210 includes a web browser application program 212 (hereafter simply referred to as a browser) and a client-side messenger application program 214 (hereafter simply referred to as a client-side messenger), among other things. It is noted that one of a variety of other commercially available document viewer application programs can be employed in place of a browser in the present technique. In general terms, the browser 212 provides a sector (not shown) on the client's 210 display device (not shown) via which the client's user can request, view and manipulate particular pages of online documents and other information. From a client/server communications perspective, the client-side messenger 214 receives specific document page requests from the browser 212, formats the requests as required for communication over the network 208, and sends the requests over the network to the ADL server 200. The server-side messenger 206 receives the specific document page requests from the network 208 and passes them to the database 202, which determines the proper course of action required by the server 200 necessary to service the requests. Assuming the ADL cache 204 contains all the information necessary to fulfill a specific document page request, the database 202 retrieves the required information from the cache and passes it to the server-side messenger 206. The server-side messenger 206 formats the information as required for communication over the network 208 into a response message, and sends the response message over the network to the particular client 210 that made the request. The client-side messenger 214 of the particular client 210 subsequently receives the response message and passes the requested document to the client's browser 212, which displays the requested page of the document to the user for viewing. In one embodiment, the server 200 automatically pre-computes and stores in its cache 204 document page layouts in an offline, background manner as the documents are initially stored on the server, or as updates to existing documents are stored on the server. This optimizes the performance of the server in responding to document requests as compared to what the server performance would be if it computed the document page layouts in an on demand, foreground manner (i.e. “on the fly”). However, if for some reason the cache 204 does not contain all the information necessary to fulfill a client's 210 specific document page request, the ADL processor 216 would first perform the required document processing to produce the required document information, and then place the information into the cache, after which it would be retrieved by the database 202 and sent to the requesting client 210 as just described.

The operational details of each of the elements shown in FIG. 2 and generally discussed heretofore are more fully described hereafter.

### 2.2 Server Processing and Storage

This section provides more detail on the operation of the aforementioned ADL server 200 and its various aforementioned components shown in FIG. 2. As discussed heretofore, the server 200 serves as the heart of the present technique. The ADL processor 216 which resides on the server 200 runs one of a variety of commercially available ADL application programs. These ADL programs process an online document to produce a high-quality online document layout that is particularly adapted to fit the specific size of the computer display sector being used to view the document. More particularly, for each document stored on the server, the server anticipates and automatically pre-computes a prescribed number of different page layouts of the entire document using the ADL program and stores the layouts in the ADL cache 204. The different document page layouts are specifically adapted to and optimized for online viewing across a prescribed range of different display sector sizes, where each different sector size contains a different number of pixels. In order to reduce the server's 200 processing and storage requirements, the difference between successive sizes in the range is quantized to a prescribed value. Based on the range of different pixel spatial resolutions supported on the display devices used in the aforementioned client computers 210 of today, in tested embodiments of the present technique the different document page layouts were automatically pre-computed and pre-optimized for viewing in display sector sizes ranging from 400×400 pixels up to 1,600×1,200 pixels using a quantization value of 20 pixels (i.e. 400×400, 420×400, 440×400 . . . 400×420, 400×440 . . . 1,600×1,200). However, it is noted that the particular range and quantization value used are arbitrary and can be prescribed based on various system parameters such as the server's 200 processing power, storage space available in the cache 204, and the different pixel spatial resolutions supported on the display devices used in the clients 210. As described hereafter, the document page layout associated with each display sector size is stored in a separate file.

In tested embodiments of the present technique the ADL processor 216 employed Microsoft® Corporation's Windows Presentation Foundation (WPF) application program. This program is based on the eXtensible Application Markup Language (XAML), which is based on the industry standard Extensible Markup Language (XML). As such, each online document stored in the ADL server 200 is authored and stored in the XAML format (i.e. doc_name.xaml), which is hereinafter referred to as a source document. It is noted that one of a variety of other commercially available ADL application programs can be substituted for the WPF program in the present technique. As such, the present technique is extensible to support document types other than those in XAML format. ® Registered trademark of Microsoft Corp. in the United States and/or other countries

### 2.2.1 Server Cache Organization

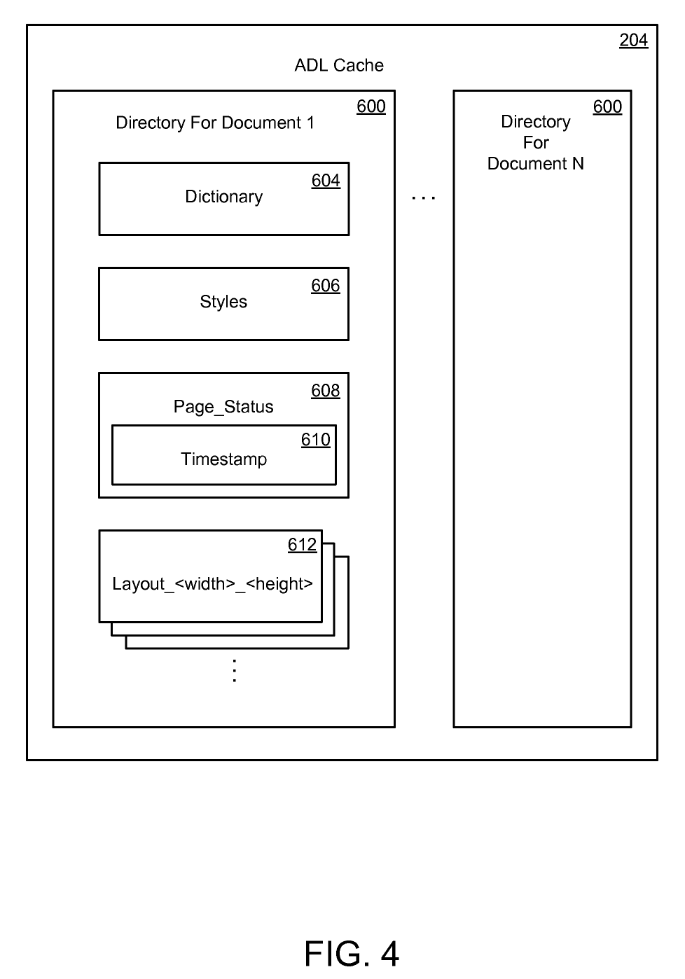

Referring to FIGS. 2 and 4, the ADL cache 204 includes a separate directory 600 for each source document, where each directory includes the following file types:
(a) dictionary 604—This file contains a dictionary of all the text that is present in the source document including, but not limited to words and their hyphenated versions, and web hyperlinks. Each particular item in the dictionary is indexed to the various layout_<width>_<height> files described hereafter. There is only one dictionary file for each source document.
(b) layout_<width>_<height> 612—This file includes the page layout information for the source document for a display sector having a width of <width> pixels and a height of <height> pixels. There is separate one of these files for each prescribed display sector size. The page layout information includes instructions as to the physical formatting of the source document when viewed in the prescribed display sector size including, but not limited to, the pagination, number of columns, and particular placement of the different types of information present in the source document, including, but not limited to words, images, animations, audio, video and web hyperlinks.
(c) page_status 608—This is a marker file including a timestamp 610 indicating when the dictionary file 604, styles file 606 and various layout_<width>_<height> files 612 were last computed from the source document. There is only one of these files for each source document.
(d) styles 606—This is a text file including the style definitions for the various contents of the document. There is only one styles file for each source document. The style definitions include, but are not limited to, font size, font family, font style and font weight. In tested embodiments of the present technique Cascading Style Sheets (CSS) declarations were used in this file.

As noted heretofore, each particular layout file 612 includes instructions as to the physical formatting and particular placement of the different types of information present in the source document. However, it is noted that the layout files 612 do not contain the actual content for this information. As also noted heretofore, the text information is contained in the aforementioned dictionary file 604. Images, animations, audio, video and other non-text forms of information that are present in the source document are stored as separate files on the server 200, and are simply referred to in the layout files 612. As such, the actual contents of the source document only needs to be stored once for all the many different page layouts that are pre-computed. This serves to optimize storage efficiency in the ADL cache 204. This also serves to optimize network 208 bandwidth and processing load on the server 200 during client/server communications, which are discussed hereafter. A similar situation exists for the information in the styles file 606.

### 2.2.2 Document Updates in Server Cache

On a periodic basis the server 200 can monitor the timestamp 610 in the page_status file 608 for each document (doc_name.xaml) 600 stored in the ADL cache 204 in order to determine if the source document has been updated since its layouts 612 were last computed by the ADL processor 216. If so, the server 200 would instruct the ADL processor 216 to compute updated anticipated layouts 612 for each document 600 that has been updated and store the updated layouts in the ADL cache 204. If the document 600 update included changes to its content, the ADL processor 216 would also compute an updated dictionary file 604 and store it in the cache 204. If the document 600 update also, or only, included updates to its style definitions, the ADL processor 216 would also, or only, compute an updated styles file 606 and store it in the cache 204.

### 2.3 Client Rendering/Display and Client/Server Communication

This section provides more detail on the operation of each aforementioned client 210 and its various aforementioned components shown in FIG. 2. This section also describes a communication protocol that takes place between each client 210 and the aforementioned server 200. As discussed heretofore, each client 210 includes a browser 212 and a client-side messenger 214, where the browser provides a sector on the client's display device via which the client's user can request, view and manipulate particular online documents and other information. The browser 212 includes a view request handler module (not shown, hereafter simply referred to as a view request handler) that runs along side the browser on the client 210 and interoperates with the messenger 214. In general, this view request handler responds to various user document viewing requests which can include, but are not limited to the following: requests to view a new document, requests to change the page of the document currently being viewed, requests to change the size of the browser display sector in which the document is being viewed, and requests to change the zoom factor of the document currently being viewed. The user can enter these requests into the client 210 in any appropriate manner via any conventional user interface provided on the client and in the browser 212. By way of example but not limitation: page change requests can be entered by the user by using page up and down keys on a keyboard connected to the client 210, or they can be entered by using a mouse connected to the client to click on “NEXT” and “PREV” (previous) icons, links or buttons provided for in the browser's 212 GUI by the view request handler as discussed hereafter; display sector size change requests can be entered by the user via the mouse and conventional click and drag method; zoom factor change requests can be entered by the user by using the mouse to click on related icons, links or buttons provided for in the browser's 212 GUI by the view request handler as discussed hereafter.

As just noted, in addition to the features described heretofore, the view request handler also provides a simple GUI in the browser 212 in conjunction with each page of the document that is displayed. In tested embodiments of the present technique the GUI provided simple clickable “NEXT” and “PREV” links at the bottom of the page which permit the user to view the next or previous pages of the document as appropriate. In other words, if the user is viewing the first page of the document only the “NEXT” link would be displayed by the GUI. If the user is viewing the second page of the document and there are three total pages, both the “NEXT” and “PREV” links would be displayed by the GUI. If the user is viewing the last page of the document, only the “PREV” link would be displayed. In tested embodiments of the present technique the GUI also provided a discrete number of clickable “ZOOM” radial buttons at the bottom of the page which permit the user to select the zoom factor with which they view the page. In tested embodiments of the present technique a document page is initially displayed at a zoom factor of 1× (i.e. no zoom) with the 1× radial button automatically selected, and the user can then simply click on another radial button to zoom in or out on the page. Once the user has zoomed in (or out) on a page they can zoom back out (or in) again simply by clicking another zoom factor radial button. It is noted that rather than using clickable buttons in the GUI that provide a discrete number of pre-determined zoom factors, the view request handler can optionally provide a sliding bar in the GUI. By way of example but not limitation, in the case of a horizontal sliding bar, if the user slides the bar all the way to the left they would see the current document page displayed at a zoom factor of 1, and if the user slides the bar all the way to the right they would see the page displayed at a maximum zoom factor. It is also noted that zoom factors less than one (i.e. zooming out on a document) can also be supported. In this case, if the user slides the bar all the way to the left they would see the current document page displayed at a minimum zoom factor (such as 0.25) and if the user slides the bar all the way to the right they would see the page displayed at a maximum zoom factor (such as 4×), and as the user slides the bar between these two positions they would see the page displayed at various zoom factors between the minimum and maximum. It is further noted that both the minimum and maximum zoom factors can be arbitrarily prescribed.

In tested embodiments of the present technique the aforementioned view request handler employed conventional JavaScript code, thus permitting application-specific JavaScript code (hereinafter referred to as a JavaScript) to be run along side the browser 212. Programming the view request handler in code such as JavaScript is advantageous since the particular user features and particular locations of the features in the displayed document page are flexible and adaptable to particular user's needs and desires. Correspondingly, in tested embodiments of the present technique AJAX (Asynchronous JavaScript and XML) calls were employed on the client 210 to request information from the server 200. Furthermore, in tested embodiments of the present technique a conventional ASP.NET program was employed as the framework for the aforementioned server-side messenger 206. The messenger 206 also employed a conventional IHttpHandler program to service particular client 210 requests received and processed by the ASP.NET framework. The operation of the view request handler and IHttpHandler programs will now be described in the context of the present technique.

### 2.4 Client/Server Process

This section provides a description of an exemplary embodiment of a client/server process for adaptive server-based layout of online documents.

### 2.4.1 Request to View New Document

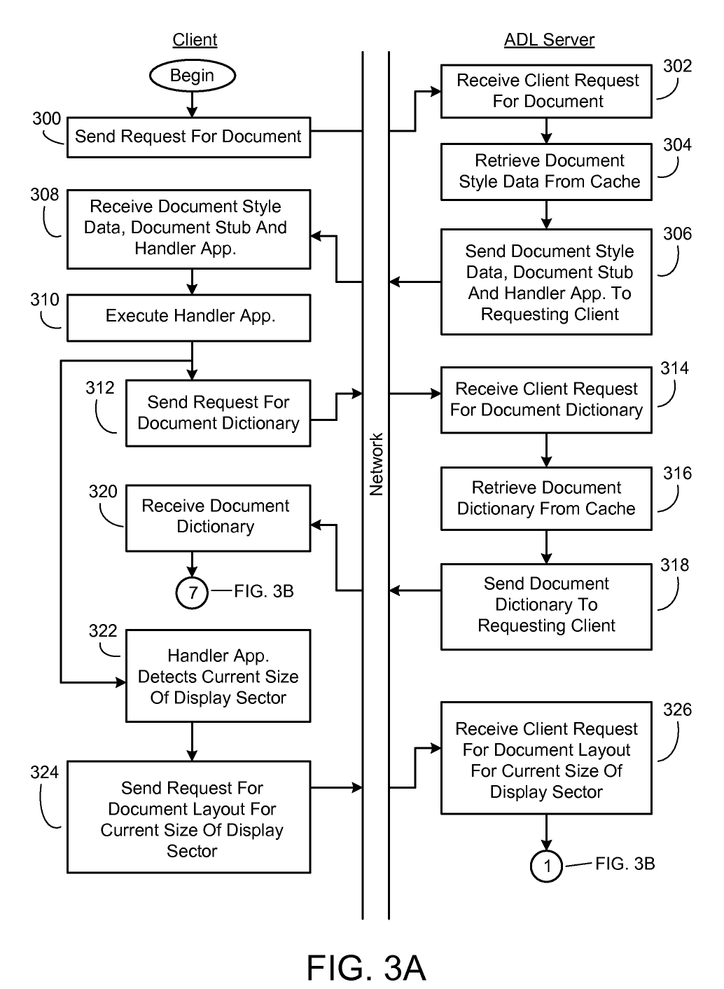

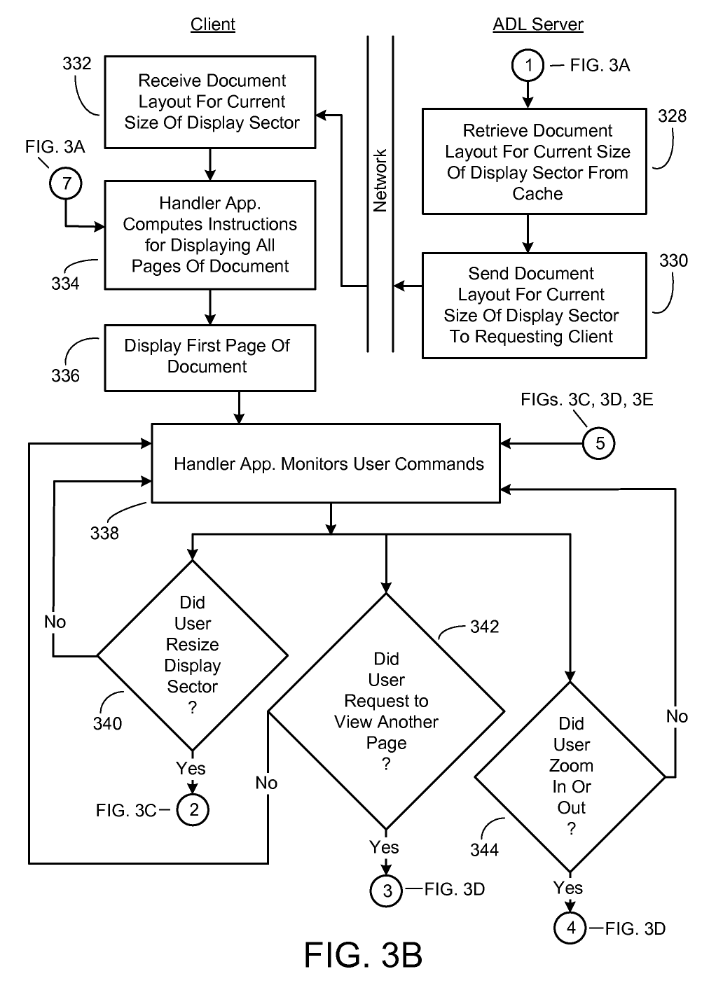

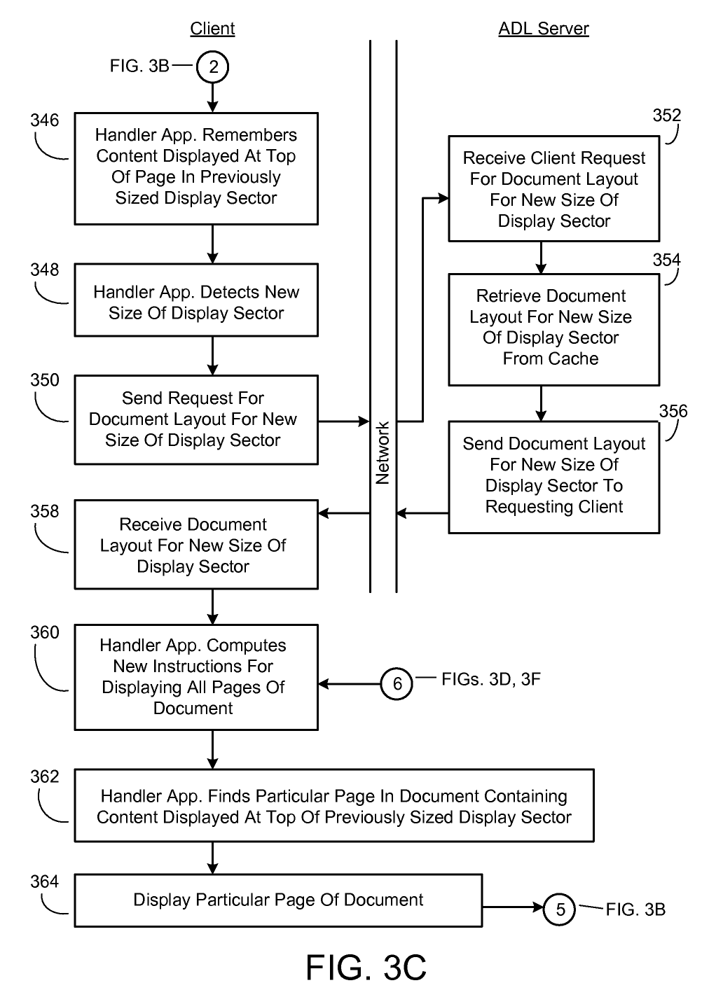

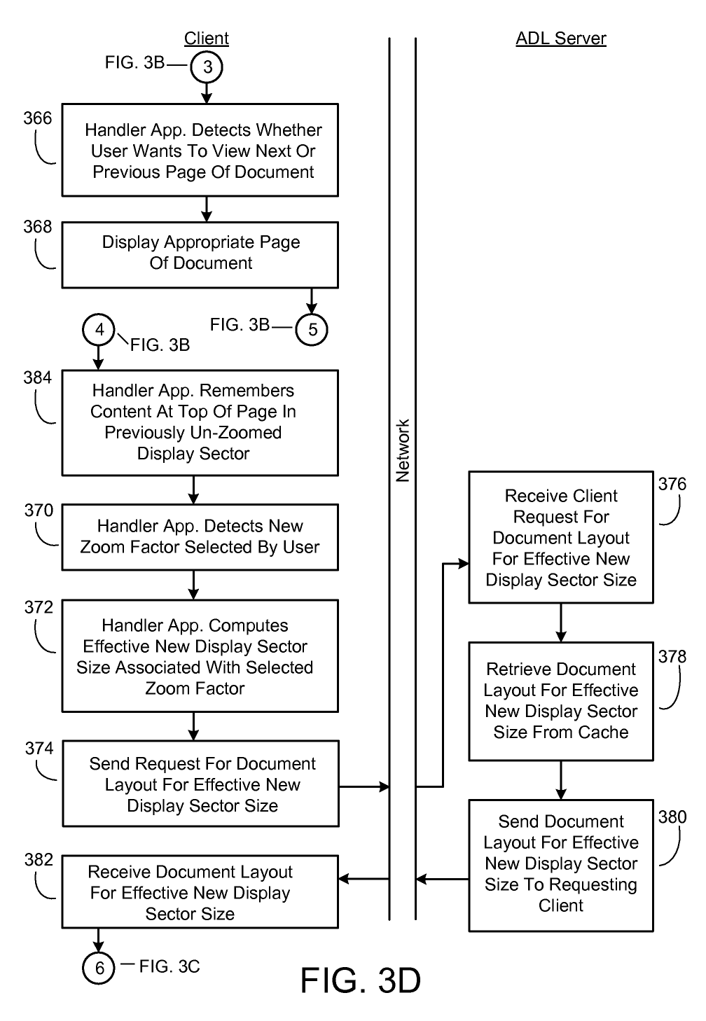

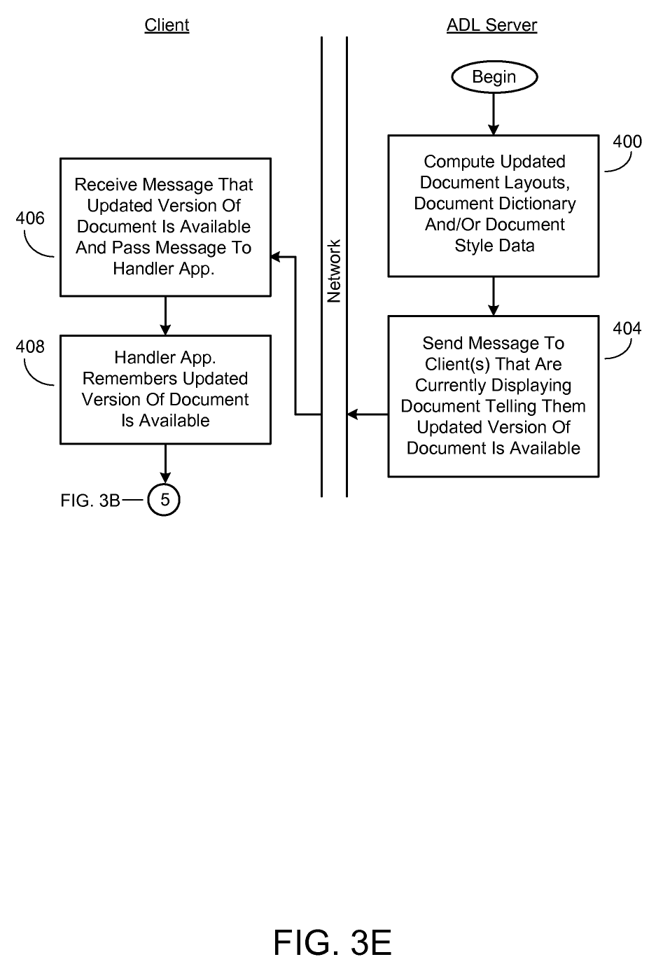

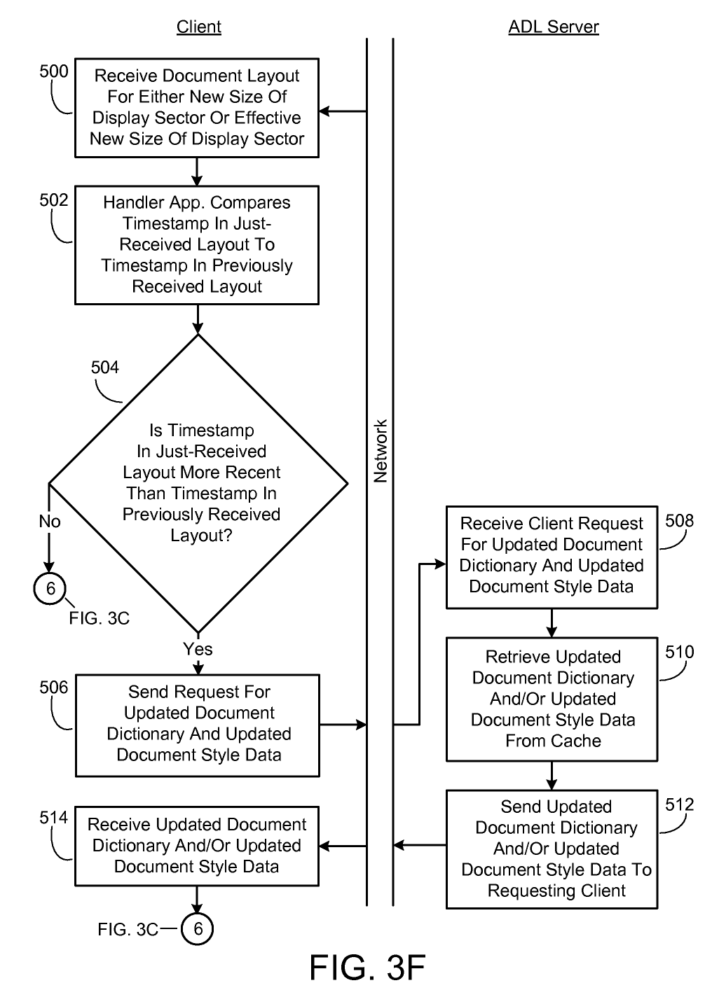

Referring to FIGS. 3A and 3B, the process starts with a user at a client entering a command to view a new (i.e. not previously displayed) document (doc_name.xaml) in a display sector on the client, and in response the client sending a request for the document over a computer network to an ADL server 300. The server receives the request for the document from the network 302 and the IHttpHandler then accesses the aforementioned directory in the aforementioned ADL cache associated with the document in order to retrieve the aforementioned style definitions file (styles) for the document 304. The server then sends the style definitions file for the document, along with a stub for the document (which serves as a placeholder for the document but does not contain any of the document's content) and a view request handler, to the requesting client over the network 306. In tested embodiments of the present process an HTML stub was employed as the document stub. The client receives the style definitions file, document stub and view request handler from the network 308. The client then automatically executes the view request handler 310, which will continue to run in the background on the client for the duration of time the user is viewing the document on the client in order to instruct the client to make additional document data requests from the server, process the additional document data received from the server, and monitor the client for further user activity, among other things. The view request handler then instructs the client to send a request for the aforementioned dictionary of all the text in the document (dictionary) over the network to the server 312. The server receives the request for the document's dictionary from the network 314 and the IHttpHandler then accesses the document's directory in the cache in order to retrieve the dictionary file 316. The server then sends the dictionary file for the document to the requesting client over the network 318. The client receives the dictionary file from the network 320. In addition, the view request handler running on the client detects the current size (width and height) of the display sector on the client in which the document is to be displayed 322 and instructs the client to send a request for the aforementioned particular document layout file for the current size of the display sector (layout_<width>_<height>) over the network to the server 324. The server receives the request for the document layout associated with the current size of the display sector from the network 326 and the IHttpHandler then accesses the document's directory in the cache in order to retrieve the layout_<width>_<height> file 328. The server then sends the layout_<width>_<height> file to the requesting client over the network 330. The client receives the layout_<width>_<height> file from the network 332. Then the view request handler running on the client uses the previously received styles and dictionary files, along with the just received layout_<width>_<height> file, to compute instructions for displaying the content of all the pages of the requested document 334, where each page is optimized for display in the current size of the client's display sector. The client then uses these instructions to render and display the first page of the requested document in the display sector on the client's display device for viewing by the user 336.

As discussed heretofore, the view request handler running on the client continues to execute in the background in order to continually monitor the client for further user commands 338 including, but not limited to, the user's resizing of the display sector that the current page of the document is being displayed in 340, the user's request to view another page of the document 342, and the user's request to zoom in or out on the current page of the document that is being displayed 344.

### 2.4.2 Resizing of Document Display Sector

Referring to FIGS. 3B and 3C, in one embodiment of the present technique, when the view request handler running on the client detects that the user entered a command to resize the display sector that a page of a document is currently being displayed in 340, the view request handler remembers the particular document content (i.e. the line of text, text block or image as the case may be) that was displayed at the top of the page in the previously sized display sector 346, detects the new size (new_width and new_height) of the display sector 348, and then instructs the client to send a request for the document layout associated with the new size of the display sector (layout_<new_width>_<new_height> for doc_name.xaml) to the server over the network 350. The server receives the request for the document layout associated with the new size of the display sector from the network 352, and the IHttpHandler then accesses the document's directory in the cache in order to retrieve the layout_<new_width>_<new_height> file associated with the new size 354. The server then sends the layout_<new_width>_<new_height> file to the requesting client over the network 356. The client receives the layout_<new_width>_<new_height> file from the network 358 and the view request handler running on the client uses the previously received styles and dictionary files, along with the just received layout_<new_width>_<new_height> file, to compute new instructions for displaying the content of all the pages of the document 360, now optimized for the new size of the client's display sector. Then the view request handler uses the aforementioned knowledge of the particular document content that was at the top of the page in the previously sized display sector to find the particular page of the new document layout that contains this information 362, and instructs the client to use these instructions to render and display this particular page of the document to the user 364 in the resized display sector on the client's display device. The view request handler can also optionally highlight the particular line of text (or text block or image as the case may be) that was at the top of the page in the previously sized display sector as an aid to the user in viewing and comprehending the new document layout.

### 2.4.3 Request to View New Page of Document

Referring to FIGS. 3B and 3D, in one embodiment of the present technique, when the view request handler running on the client detects that the user entered a command to view another page of a document they are already viewing 342, the view request handler detects whether the user wants to view the next or previous page of the document 366. Based on the fact that instructions for displaying the content of all the pages of the document were previously computed by the view request handler, all it has to do is simply instruct the client to use these instructions to render and display the appropriate new page of the document to the user 368 on the client's display device.

### 2.4.4 Request to Zoom in or Out on Document

Referring to FIGS. 3B, 3C and 3D, in one embodiment of the present technique, when the view request handler running on the client detects that the user entered a command to zoom in or out on a page of a document that is currently being displayed 344, the view request handler remembers the particular document content that was displayed at the top of the page in the previously un-zoomed display sector 384. The view request handler then detects the new zoom factor selected by the user 370, computes an effective new display sector size associated with the selected zoom factor 372 in the manner described hereafter, and instructs the client to send a request for the document layout associated with the effective new display sector size over the network to the server 374. The server receives the request for the document layout associated with the effective new display sector size from the network 376 and the IHttpHandler then accesses the document's directory in the cache in order to retrieve the document layout associated with the effective new display sector size 378. The server then sends the document layout associated with the effective new display sector size to the requesting client over the network 380. The client receives the document layout associated with the effective new display sector size from the network 382. From this point on, aforementioned process steps 360, 362 and 364 are performed as shown in FIG. 3C.

After detecting a new zoom factor selected by the user, the view request handler computes the effective new display sector size associated with the selected zoom factor by dividing the current pixel width and pixel height of the display sector by the zoom factor, and then rounding the result down to the nearest pre-computed layout size that is available in the cache. Since the view request handler is sent to the client by the server, the view request handler knows the prescribed range of different display sector sizes and the related prescribed difference between successive sizes in the range that are supported by the ADL processor on the server. By way of example, but not limitation, if the user is currently viewing a document page at a 1× zoom factor in a display sector size of 500×500 pixels and the user then selects a 1.2× zoom factor, the view request handler would compute the effective new display sector size to be 416×416 pixels and then round this down to 400×400 pixels based on a 20-pixel increment between successive layout sizes that are pre-computed by the ADL processor. Thus, the view request handler would instruct the client to request a new layout file for the document for a sector size of 400×400 pixels (layout_{—}<400>_{—}<400>).

In order to address the situation where the client user's selection of a zoom factor results in the display of a new layout of the current document page which fills only a portion of the display sector, the view request handler can also employ a magnification feature in which the new layout retrieved from the server is automatically magnified in order to fill as much of the display sector as possible. This magnification feature applies to the entire range of prescribed zoom factors. By way of example, but not limitation, in the case where a document page is currently displayed in a sector size of 800×800 pixels and the user then selects a 2× zoom factor, the 400×400 pixel layout sent to the client by the server would automatically be magnified by 2× by the client's view request handler so as to fill the entire display sector size (rather than just a quarter of it). It is noted that the magnification factor is selected by the view request handler in order to fill as much of the display sector as possible.

### 2.4.5 Updates to Document

As discussed heretofore, the anticipated layouts (layout_<width>_<height>), dictionary and/or styles files associated with a document stored in the server's cache can be automatically updated whenever the source document is updated. The following is a discussion of what happens when a document's files are updated in the cache after a user at a client is viewing a page of the document.

Referring to FIGS. 3B and 3C, in one embodiment of the present technique in the aforementioned event that the user enters a command to resize the display sector that a page of a document is currently being displayed in 340, aforementioned process steps 346, 348, 350 and 352 are performed as shown in FIG. 3C. However, process step 354 is modified such that when the IHttpHandler accesses the document's directory in the cache, it determines if the styles file or the dictionary file have been updated since they were last transmitted to the client and then if so, rather than retrieving only the layout_<new_width>_<new_height> file, the IHttpHandler also retrieves whichever of the styles and/or dictionary files that have been updated from the cache. Then, process steps 356 and 358 are modified such that rather than the server sending only the layout_<new_width>_<new_height> file and the requesting client receiving only this file, the server also sends and the client also receives whichever of the styles and/or dictionary files that have been updated. Then aforementioned process steps 360, 362 and 364 are performed as shown in FIG. 3C so that the updated document content is displayed to the user.

Referring to FIGS. 3B, 3C and 3D, in one embodiment of the present technique in the aforementioned event that the user enters a command to zoom in or out on a page of a document that is currently being displayed 344, aforementioned process steps 384, 370, 372, 374 and 376 are performed as shown in FIG. 3D. However, process step 378 is modified such that when the IHttpHandler accesses the document's directory in the cache, it determines if the styles file and/or dictionary file have been updated since they were last transmitted to the client and then if so, rather than retrieving only the layout associated with the effective new display sector size, the IHttpHandler also retrieves whichever of the styles and/or dictionary files that have been updated from the cache. Then, process steps 380 and 382 are modified such that rather than the server sending only the layout associated with the effective new display sector size and the requesting client receiving only this file, the server also sends and the client also receives whichever of the styles and/or dictionary files that have been updated. Then aforementioned process steps 360, 362 and 364 are performed as shown in FIG. 3C so that the updated document content is displayed to the user.

Hereafter are described additional ways in which the server could provide updated layout information to particular clients whose users are currently viewing documents for which the content has since been updated.

### 2.4.5.1 Send Message to Clients

Referring to FIG. 3E, in one embodiment of the present technique whenever the server computes updated anticipated layout files, an updated dictionary file, and/or an updated styles file associated with a document stored in the server's cache 400, the server could send a message over the network to the particular client(s) that are currently displaying the document telling them that an updated version of the document is available 404. The client would receive this message from the network and pass it to the view request handler 406. The view request handler would remember that an updated version of the document is available on the server 408 and respond as follows.

Referring to FIGS. 3B and 3C, in the aforementioned event that the user enters a command to resize the display sector that a page of the updated document is currently being displayed in 340, aforementioned process steps 346 and 348 would be performed as shown in FIG. 3C. However, process step 350 would be modified such that the view request handler, besides instructing the client to send a request over the network to the server for the new layout file (layout_<new_width>_<new_height>) as described heretofore, would also instruct the client to send another request over the network to the server for the updated dictionary and/or styles files. Process steps 352, 354, 356 and 358 would also be modified accordingly such that the server would receive both these requests from the network, the IHttpHandler would retrieve the new layout file along with the updated dictionary and/or styles files (only the files in the cache which have changed would be sent as described heretofore), the server would send these files to the requesting client over the network, and the client would receive these files. Then aforementioned process steps 360, 362 and 364 would be performed as shown in FIG. 3C so that the updated document layout could be displayed to the user.

Referring to FIGS. 3B, 3C and 3D, in the aforementioned event that the user enters a command to zoom in or out on a page of the updated document that is currently being displayed 344, aforementioned process steps 384, 370 and 372 would be performed as shown in FIG. 3D. However, process step 374 would be modified such that the view request handler, besides instructing the client to send a request over the network to the server for the layout associated with the effective new display sector size as described heretofore, would also instruct the client to send another request over the network to the server for the updated dictionary and/or styles files. Process steps 376, 378, 380 and 382 would also be modified accordingly such that the server would receive both these requests from the network, the IHttpHandler would retrieve the new layout file along with the updated dictionary and/or styles files (only the files in the cache which have changed would be retrieved as described heretofore), the server would send these files to the requesting client over the network, and the client would receive these files. Then aforementioned process steps 360, 362 and 364 would be performed as shown in FIG. 3C so that the updated document layout could be displayed to the user.

### 2.4.5.2 Put Timestamp Information in Layout Files

As an alternative to the technique described in the preceding section for providing updated layout information to particular clients whose users are currently viewing documents which have since been updated, in another embodiment of the present technique, the ADL processor could place the aforementioned timestamp information directly in the various layout_<width>_<height> files located in the server's cache. In this case, aforementioned process steps 358 and 382 would be modified as follows.

Referring to FIG. 3F, after the client receives the document layout file for either the new size or the effective new size of the display sector from the network 500, the view request handler running on the client would compare the timestamp in the just-received layout file to the timestamp in the previously received layout file 502. If the timestamp in the just-received layout file is not more recent than the timestamp in the previously received layout file 504, process steps 360, 362 and 364 would be performed as shown in FIG. 3C using the previously received document styles and dictionary files, along with the just received document layout file. If the timestamp in the just-received layout file is more recent than the timestamp in the previously received layout file 504, the view request handler would instruct the client to send a request for the updated document dictionary and styles files over the network to the server 506. The server would receive the request for the updated document dictionary and styles files from the network 508 and the IHttpHandler would then access the document's directory in the cache in order to retrieve the updated dictionary and/or styles files (only the files in the cache which have changed would be retrieved as described heretofore) 510. The server would then send the updated document dictionary and/or styles files to the requesting client over the network 512. The client would receive the updated document dictionary and/or styles files from the network 514, and then process steps 360, 362 and 364 would be performed as shown in FIG. 3C using these just received files along with the just received document layout file.

### 3.0 Additional Embodiments

While the present technique has been described in detail by specific reference to embodiments thereof, it is understood that variations and modifications thereof may be made without departing from the true spirit and scope of the present technique. It is also noted that any or all of the aforementioned alternate embodiments may be used in any combination desired to form additional hybrid embodiments. Although the subject matter has been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

Wherefore, what is claimed is:

1. A computer-implemented process for providing data for displaying online documents generated by an adaptive document layout application to client computers over a client/server based network, comprising using a server computer and a document cache on the server to perform the following process actions:
receiving a request for a document, said document request coming from a client computer over the network;
sending a view request handler module to the requesting client over the network in response to said document request;
retrieving style data for the document from the cache;
sending the document style data to the requesting client over the network;
receiving a request for a dictionary for the document, said document dictionary request coming from the client over the network upon instruction from the view request handler module;
retrieving the document dictionary from the cache;
sending the document dictionary to the requesting client over the network in response to said dictionary request;
receiving a request for a layout of the document, said document layout request coming from the client over the network upon instruction from the view request handler module, and specifying a current size of a display sector on the client in which the document is to be displayed;
retrieving the document layout associated with the specified current display sector size from the cache; and
sending the document layout associated with the specified current display sector size to the requesting client over the network in response to said layout request.

2. The process of claim 1, further comprising the process action of sending a document stub to the requesting client over the network, wherein the document stub serves as a placeholder for the document but does not contain any of the document's content.

3. The process of claim 1, further comprising the process actions of:
receiving a request for a layout of the document coming from the client over the network, said request specifying a revised display sector size;
retrieving a document layout associated with the specified revised display sector size from the cache; and
sending the document layout associated with the specified revised display sector size to the requesting client over the network.

4. The process of claim 3, further comprising the process actions of:
prior to retrieving a document layout associated with the specified revised display sector size from the cache, determining if the document style data or the document dictionary have been updated in the cache since they were last sent to the requesting client; and
whenever it is determined the document style data or document dictionary have been updated,
retrieving the updated document style data and/or updated document dictionary from the cache, and
sending the updated document style data and/or updated document dictionary to the requesting client over the network.

5. A computer-implemented process for obtaining data for displaying online documents generated by an adaptive document layout application from a server computer over a client/server based network, comprising using a client computer to perform the following process actions:
sending a request for a document over the network to the server in response to a user on a client computer entering a command to view a new document in a display sector on the client;
receiving a view request handler module, said module coming from the server over the network;
receiving style data for the document, said document style data coming from the server over the network; and
executing the view request handler, which continues to run in the background on the client for the duration of time the user is viewing the document, wherein the view request handler,
instructs the client to send a request for a dictionary for the document over the network to the server,
detects a current size of the display sector,
instructs the client to send a request for a layout of the document over the network to the server, said document layout request specifying the current size of the display sector,
receives the document dictionary and the document layout associated with the specified current display sector size, said dictionary and layout coming from the server over the network,
computes instructions for displaying all pages of the document using the style data, dictionary and layout associated with the specified current display sector size, wherein each page is optimized for display in the current size of the display sector, and
provides the display instructions to the client for rendering and displaying a page of the document in the display sector.

6. The process of claim 5, further comprising the action of receiving a document stub which serves as a placeholder for the document but does not contain any of the document's content, said document stub coming from the server over the network.

7. The process of claim 5, further comprising the process actions of:
the view request handler monitoring the client for a user command to resize the display sector that a page of the document is being displayed in; and
whenever it is detected that the user entered a command to resize the display sector, the view request handler,
detects the new size of the display sector,
instructs the client to send a request for a layout of the document over the network to the server, said document layout request specifying the new size of the display sector in which a resized page of the document is to be displayed,
receives a new document layout associated with the specified new display sector size, said new layout coming from the server over the network,
computes new instructions for displaying all the pages of the document using the previously received style data and dictionary, and the just-received new layout associated with the specified new display sector size, wherein each page is optimized for display in the resized display sector, and
provides the new display instructions to the client for rendering and displaying a page of the document in the resized display sector.

8. The process of claim 7, wherein whenever it is detected that the user entered a command to resize the display sector, the view request handler further,
remembers the particular document content that was displayed at the top of the page in the previously sized display sector, and
finds a particular page of the new document layout associated with the specified new display sector size that contains said particular document content, and
wherein the process action of providing the new display instructions to the client for rendering and displaying a new page of the document in the resized display sector comprises providing new display instructions to the client for rendering and displaying said particular document page in the resized display sector.

9. The process of claim 8, wherein the process action of providing new display instructions to the client for rendering and displaying said particular document page in the resized display sector further comprises an action of the view request handler highlighting the particular document content that was displayed at the top of the page in the previously sized display sector.

10. The process of claim 5, wherein the document has been updated on the server after the client received the document style data and dictionary, and further comprising the process actions of:
the view request handler monitoring the client for a user command to resize the display sector that a page of the document is being displayed in; and
whenever it is detected that the user entered a command to resize the display sector, the view request handler,
detects the new size of the display sector,
instructs the client to send a request for a layout of the document over the network to the server, said document layout request specifying the new size of the display sector in which a resized page of the document is to be displayed,
receives updated style data for the document if it was updated after the client last received the document style data, said updated style data coming from the server over the network,
receives an updated document dictionary if it was updated after the client last received the document dictionary, said updated dictionary coming from the server over the network,
receives a new document layout associated with the specified new display sector size, said new layout coming from the server over the network,
computes new instructions for displaying all the pages of the document using the just-received updated style data and/or updated dictionary, the just-received new layout associated with the specified new display sector size, and the previously received style data and/or dictionary as needed if an updated version was not received, wherein each page is optimized for display in the resized display sector, and
provides the new display instructions to the client for rendering and displaying a page of the document in the resized display sector.

11. The process of claim 5, further comprising the process actions of:
the view request handler monitoring the client for a user command to view another page of the document; and
whenever it is detected that that the user entered a command to view another page of the document, the view request handler,
detects whether the user wants to view a next or a previous page of the document, and
provides the display instructions to the client for rendering and displaying the appropriate new page of the document in the display sector, wherein the previously computed instructions for displaying all the pages of the document are used.

12. The process of claim 5, further comprising the process actions of:
the view request handler monitoring the client for a user command to zoom in or out on a page of the document that is being displayed; and
whenever it is detected that the user entered a command to zoom in or out on a page of the document, the view request handler,
detects a new zoom factor which is specified by the user,
computes an effective new display sector size associated with the specified zoom factor by dividing the display sector's pixel width and pixel height by the specified zoom factor and then rounding the result down to the nearest layout size that is available on the server,
instructs the client to send a request for a layout of the document over the network to the server, said document layout request specifying the effective new size of the display sector in which a zoomed page of the document is to be displayed,
receives a new document layout associated with the specified effective new display sector size, said new layout coming from the server over the network,
computes new instructions for displaying a zoomed representation of all the pages of the document using the previously received style data and dictionary, and the just-received new layout associated with the specified effective new display sector size, wherein each zoomed page is optimized for display in the display sector, and
provides the new display instructions to the client for rendering and displaying the zoomed representation of a page of the document in the display sector.

13. The process of claim 12, wherein whenever it is detected that the user enters a command to zoom in or out on a page of the document that is being displayed, the view request handler further,
remembers the particular document content that was displayed at the top of the page in the previously un-zoomed display sector, and
finds a particular page of the new document layout associated with the specified effective new display sector size that contains said particular document content, and
wherein the process action of providing the new display instructions to the client for rendering and displaying the zoomed representation of a new page of the document in the display sector comprises providing new display instructions to the client for rendering and displaying the zoomed representation of said particular document page in the display sector.

14. The process of claim 13, wherein the process action of providing new display instructions to the client for rendering and displaying the zoomed representation of said particular document page in the display sector further comprises an action of the view request handler highlighting the particular document content that was displayed at the top of the page in the previously un-zoomed display sector.

15. The process of claim 13, further comprising the action of the view request handler further magnifying the new document layout associated with the specified effective new display sector size, wherein,
the magnification is performed in situations where the new layout fills only a portion of the display sector, and
the magnification factor is selected by the view request handler in order to fill as much of the display sector as possible.

16. The process of claim 5, wherein the document has been updated on the server after the client received the document style data and dictionary, and further comprising the actions of:
the view request handler monitoring the client for a user command to zoom in or out on a page of the document that is being displayed; and
whenever it is detected that the user entered a command to zoom in or out on a page of the document, the view request handler,
detects a new zoom factor which is specified by the user,
computes an effective new display sector size associated with the specified zoom factor by dividing the display sector's pixel width and pixel height by the specified zoom factor and then rounding the result down to the nearest layout size that is available on the server,
instructs the client to send a request for a layout of the document over the network to the server, said document layout request specifying the effective new size of the display sector in which a zoomed page of the document is to be displayed,
receives updated style data for the document if it was updated after the client last received the document style data, said updated style data coming from the server over the network,
receives an updated document dictionary if it was updated after the client last received the document dictionary, said updated dictionary coming from the server over the network,
receives a new document layout associated with the specified effective new display sector size, said new layout coming from the server over the network,
computes new instructions for displaying a zoomed representation of all the pages of the document using the just-received updated style data and/or updated dictionary, the just-received new layout associated with the specified effective new display sector size, and the previously received style data and/or dictionary as needed if an updated version was not received, wherein each zoomed page is optimized for display in the display sector, and
provides the new display instructions to the client for rendering and displaying the zoomed representation of a page of the document in the display sector.

17. The process of claim 5, further comprising the actions of:
receiving a message from the server over the network that an updated version of the document is available, and whenever said message is received, the view request handler,
instructs the client to send a request over the network to the server for updated style data for the document if the message indicates the style data was updated,
instructs the client to send a request over the network to the server for an updated document dictionary if the message indicates the dictionary was updated,
receives updated style data for the document and/or an updated document dictionary, said updated style data and/or dictionary coming from the server over the network,
uses the just-received updated style data and/or updated dictionary in lieu of the previously received style data and/or dictionary whenever computing new instructions for displaying all the pages of the document.

18. The process of claim 5, wherein the document layout associated with the specified current display sector size comprises a timestamp indicating when the document was last updated, and further comprising the process action of:
the view request handler monitoring the client for a user command to change the page of the document that is currently being displayed in a specified manner that affects its layout; and
whenever it is detected that the user entered a command to change the page of the document that is currently being displayed in a specified manner that affects its layout, the view request handler,
instructs the client to send a request for a new layout of the document over the network to the server, said document layout request specifying the new size of the display sector in which a page of the document is to be displayed,
receives a new document layout associated with the specified new display sector size, said new document layout coming from the server over the network,
compares the timestamp in the just-received new layout to the timestamp in the previously received layout,
whenever the timestamp in the just-received new layout is not more recent than the timestamp in the previously received layout, computes new instructions for displaying all the pages of the document using the previously received style data and dictionary, and the just-received new layout associated with the specified new display sector size, wherein each page is optimized for display in the display sector,
whenever the timestamp in the just-received new layout is more recent than the timestamp in the previously received layout,
instructs the client to send requests over the network to the server for updated document style data and an updated document dictionary,
receives updated document style data if the style data has been updated and/or an updated document dictionary if the dictionary has been updated, said updated style data and/or dictionary coming from the server over the network, and
computes new instructions for displaying all the pages of the document using the just-received updated style data and/or updated dictionary, the just received new layout associated with the specified new display sector size, and the previously received style data and/or dictionary as needed if an updated version was not received, wherein each page is optimized for display in the display sector,
finds a particular page of the new document layout associated with the specified new display sector size that contains the particular document content that was displayed at the top of the page in the previously sized display sector, and
provides the new display instructions to the client for rendering and displaying said particular document page in the display sector.

19. A system for providing data for displaying online documents generated by an adaptive document layout (ADL) application to one or more client computers over a client/server based network, wherein a page of the documents is viewed in a display sector on the clients, comprising:
a general purpose computing device;
a cache located on the general purpose computing device; and
a computer program comprising program modules executable by the computing device, wherein the computing device is directed by the program modules to,
compute a prescribed number of different layouts for each document stored on the computing device using the ADL application, wherein,
the layouts for each document are automatically computed for the entire document in an offline, background manner when the document is initially stored on the computing device,
each particular layout is specifically adapted to and optimized for viewing in a particular display sector size such that the prescribed number of different layouts are computed for a prescribed range of different display sector sizes, wherein each different display sector size comprises a different number of pixels,
the cache comprises a separate directory for each document, wherein the directory comprises,
all the different layouts for the document, wherein each layout is stored in a separate file,
a dictionary file, which is also computed by the ADL application, comprising a dictionary of all the text in the document, wherein each particular item of text is indexed to all the layouts, and wherein a single dictionary file is shared by all the layouts,
a styles file, which is also computed by the ADL application, comprising style definitions for the content in the document, wherein a single styles file is shared by all the layouts, and
a status file comprising a timestamp indicating when the document was last updated.

20. The system of claim 19, wherein,
the difference between successive sizes in the prescribed range of different display sector sizes is quantized to a prescribed value,
the prescribed range and prescribed value are selected based upon one or more parameters comprising,
processing power of the computing device,
storage space available in the cache, and
pixel spatial resolutions of display devices used on the clients, and
the computing device is further directed by the program modules to,
monitor the timestamp for each document in the cache on a periodic basis in order to determine if the document has been updated since the layout files for the document were last computed, and
whenever it is determined that a particular document has been updated since the layout files for said document were last computed, compute updated layout files, along with an updated dictionary file and/or updated styles file as necessary, for said document using the ADL application and store all the updated files in the cache.
